(19) United States
(12) Patent Application Publication
(10) Pub. No.: US 2023/0137219 A1
(43) Pub. Date: May 4, 2023

(54) IMAGE PROCESSING SYSTEM AND METHOD IN METAVERSE ENVIRONMENT

(71) Applicant: MAXST CO., LTD., Seoul (KR)

(72) Inventors: Seung Gyun KIM, Seoul (KR); Tae Yun SON, Gyeonggi-do (KR); Jae Wan PARK, Gyeonggi-do (KR)

(21) Appl. No.: 17/545,222

(22) Filed: Dec. 8, 2021

(30) Foreign Application Priority Data
Nov. 3, 2021 (KR) 10-2021-0149459

(51) Int. Cl. H04N 13/183; H04N 13/383; H04N 13/349; H04W 4/02; H04W 4/38

(52) U.S. Cl. CPC H04N 13/183; H04N 13/383; H04N 13/349; H04W 4/025; H04W 4/38

(57) ABSTRACT

An image processing system according to an embodiment includes a spatial map server that generates a spatial map by using a point cloud and viewpoint videos from first real space images obtained by scanning real space, a location recognition server that stores location recognition data extracted from the spatial map, and compares the location recognition data with a second real space image obtained through a device of an AR user to identify location information of the device of the AR user on the spatial map, and a communication server that stores and provides the location information of the device of the AR user on the spatial map and a location of a VR user on the spatial map, and displays at least one or more AR users and at least one VR user on the spatial map in synchronization with each other by using the location information and the location.

### CROSS-REFERENCE TO RELATED APPLICATION AND CLAIM OF PRIORITY

This application claims the benefit under 35 USC § 119(a) of Korean Patent Application No. 10-2021-0149459, filed on Nov. 3, 2021, in the Korean Intellectual Property Office, the entire disclosure of which is incorporated herein by reference for all purposes.

### BACKGROUND

### 1. Field

Embodiments of the present disclosure relate to an image processing system and method in a metaverse environment.

### 2. Description of Related Art

Since most metaverse services currently provided are implemented only in virtual reality and do not directly interact with reality, there is an opinion that the metaverse services are less realistic for service users.

Augmented reality (AR) is a technology that combines virtual objects or information with a real environment to make the virtual objects look like objects that exist in reality, and is also proposed in the form of a mirror world through virtualization of real space.

Meanwhile, a metaverse service operator is currently conducting research to provide a more realistic and dynamic service environment to users by applying both the virtual reality and augmented reality described above.

### SUMMARY

Embodiments of the present disclosure are intended to provide an image processing system and method in a metaverse environment for providing a video with increased sense of immersion in the metaverse environment.

In addition, embodiments of the present disclosure are intended to provide various services between AR users and VR users existing in the same spatial map in the metaverse environment.

According to an exemplary embodiment of the present disclosure, an image processing system in a metaverse environment includes a spatial map server that generates a spatial map by using a point cloud and a plurality of viewpoint videos from a plurality of first real space images obtained by scanning real space, a location recognition server that stores location recognition data extracted from the spatial map, and compares the location recognition data with a second real space image obtained through a device of an AR user to identify location information of the device of the AR user on the spatial map, and a communication server that stores and provides the location information of the device of the AR user on the spatial map and a location of a VR user on the spatial map, and displays at least one or more AR users and at least one or more VR users on the spatial map in synchronization with each other by using the location information and the location.

The location recognition data may include a three-dimensional location value of a point in the spatial map and a plurality of first descriptors matched to the three-dimensional location value.

The location recognition server may compare the plurality of first descriptors extracted from the location recognition data with a plurality of second descriptors extracted from the second real space image to identify the location information of the device of the AR user including location coordinates and a gaze direction of the device of the AR user on the spatial map.

The communication server may identify the at least one or more AR users or the at least one or more VR users existing on the same spatial map by identifying, based on the location information of the device of the AR and the location of the VR user, whether or not a condition including at least one or more of proximity of the AR user and VR user to each other, whether or not the AR user and VR user exist within a specific region, whether or not the AR user and VR user use a specific service, and whether or not the AR user and VR user belong to the same group is satisfied.

The communication server may provide at least one or more services of a chat service, a video call service, and a data transmission service between the at least one or more AR users and the at least one or more VR users located on the same spatial map.

The spatial map server may identify a location corresponding to the second real space image on the spatial map by using the second real space image photographed in real time from the device of the AR user and the location information of the device of the AR user, and overlay the second real space image on the identified location on the spatial map to provide the second real space image to the device of the VR user.

The image processing system in the metaverse environment may further include a device of a VR user that identifies a location corresponding to the second real space image on the spatial map by using the second real space image photographed in real time from the device of the AR user and the location information of the device of the AR user, and overlay the second real space image on the identified location on the spatial map to display the second real space image on a screen.

The device of the VR user may display the spatial map on the screen by including the AR user on the spatial map by using the location information of the device of the AR user.

The image processing system in the metaverse environment may further include a device of an AR user that displays the VR user on the second real space image photographed in real time by using the location of the VR user on the spatial map transmitted from the communication server.

According to another exemplary embodiment of the present disclosure, an image processing system in a metaverse environment includes a device of a VR user that stores a spatial map generated by using a point cloud and a plurality of viewpoint videos from a plurality of first real space images, identifies a location corresponding to a second real space image photographed in real time from a device of an AR user on the spatial map by using the second real space image and location information of the device of the AR user, and overlays the second real space image on the identified corresponding location of the spatial map to display the second real space image on a screen, the device of the AR user that stores location recognition data extracted from the spatial map, compares the location recognition data with the second real space image obtained by scanning real space, and identifies and provides location information of the device of the AR user on the spatial map, and a communication server that stores and provides the location information of device of the AR user on the spatial map and a location of a VR user on the spatial map, and displays at least one or more AR users or at least one or more VR users on the spatial map in synchronization with each other by using the location information and the location.

The device of the AR user may compare a plurality of first descriptors extracted from the location recognition data with a plurality of second descriptors extracted from the second real space image to identify the location information of the device of the AR user including location coordinates and a gaze direction of the device of the AR user on the spatial map.

The device of the VR user may display the spatial map on the screen by including the AR user on the spatial map by using the location information of the device of the AR user.

The communication server may identify the at least one or more AR users or the at least one or more VR users existing on the same spatial map by identifying, based on the location information of the device of the AR and the location of the VR user, whether or not a condition including at least one or more of proximity of the AR user and VR user to each other, whether or not the AR user and VR user exist within a specific region, whether or not the AR user and VR user use a specific service, and whether or not the AR user and VR user belong to the same group is satisfied.

The communication server may provide at least one or more services of a chat service, a video call service, and a data transmission service between the at least one or more AR users and the at least one or more VR users located on the same spatial map.

The device of the AR user may display the VR user on the second real space image photographed in real time by using the location of the VR user on the spatial map transmitted from the device of the VR user.

According to still another exemplary embodiment of the present disclosure, an image processing method in a metaverse environment includes generating a spatial map by using a point cloud and a plurality of viewpoint videos from a plurality of first real space images obtained by scanning real space, extracting location recognition data from the spatial map, identifying location information of a device of an AR user on the spatial map by comparing the location recognition data with a second real space image obtained through the device of the AR user, and displaying at least one or more AR users and at least one or more VR users on the spatial map in synchronization with one another by using the location information of the device of the AR user and a location of a VR user on the spatial map.

The location recognition data may include a three-dimensional location value of a point in the spatial map and a plurality of first descriptors matched to the three-dimensional location value, and the identifying of the location information of the device of the AR user may include receiving the second real space image photographed by the device of the AR user, extracting a two-dimensional position value of a point in the second real space image and a plurality of second descriptors matching to the two-dimensional position value, and determining location information of the device of the AR user including location coordinates and a gaze direction of the device of the AR user on the spatial map by comparing the plurality of first descriptors with the plurality of second descriptors.

In the image processing method in the metaverse environment, in the displaying of the at least one or more AR users and at least one or more VR users on the spatial map in synchronization with each other, the at least one or more AR users or the at least one or more VR users existing on the same spatial map may be identified by identifying, based on the location information of the device of the AR and the location of the VR user, whether or not a condition including at least one or more of proximity of the AR user and VR user to each other, whether or not the AR user and VR user exist within a specific region, whether or not the AR user and VR user use a specific service, and whether or not the AR user and VR user belong to the same group is satisfied.

The image processing method in the metaverse environment may further include, after the displaying of the at least one or more AR users and at least one or more VR users on the spatial map in synchronization with each other, providing at least one or more services of a chat service, a video call service, and a data transmission service between the at least one or more AR users and the at least one or more VR users located on the same spatial map.

The image processing method in the metaverse environment may further include, after the displaying of the at least one or more AR users and at least one or more VR users on the spatial map in synchronization with each other, identifying a location corresponding to the second real space image on the spatial map using the second real space image photographed in real time from the device of the AR user and the location information of the device of the AR user, and overlaying the second real space image on the identified location to display the second real space image on the identified location of the spatial map.

According to embodiments of the present disclosure, since a real space image photographed through the device of the AR user is mapped and provided on the spatial map constructed based on the real space, it is possible to expect the effect of being provided with a metaverse-based service that reflects a more realistic video from the perspective of the VR user.

In addition, according to embodiments of the present disclosure, since not only the location of the VR user on the spatial map but also the location of the device of the AR user can be identified, various services, including chatting and data transmission and reception, can be provided between the VR user and the AR user located on the same spatial map.

### BRIEF DESCRIPTION OF THE DRAWINGS

FIG. 1 is a block diagram illustrating an image processing system in a metaverse environment according to an embodiment of the present disclosure.

FIGS. 2 and 3 are exemplary diagrams for describing a method of identifying location information of a device of an AR user according to an embodiment of the present disclosure.

FIGS. 4 and 5 are exemplary diagrams for describing a case in which a real space image is reflected in a spatial map according to an embodiment of the present disclosure.

FIG. 6 is an exemplary diagram of a screen of a device of a VR user according to an embodiment of the present disclosure.

FIG. 7 is an exemplary diagram of a screen of the device of the AR user according to an embodiment of the present disclosure.

FIG. 8 is a block diagram for describing an image processing system in a metaverse environment according to another embodiment of the present disclosure.

FIG. 9 is a flowchart for describing an image processing method in a metaverse environment according to an embodiment of the present disclosure.

FIG. 10 is a block diagram for illustratively describing a computing environment including a computing device according to an embodiment of the present disclosure.

### DETAILED DESCRIPTION

Hereinafter, a specific embodiment will be described with reference to the drawings. The following detailed description is provided to aid in a comprehensive understanding of the methods, apparatus and/or systems described herein. However, this is illustrative only, and the present disclosure is not limited thereto.

In describing the embodiments, when it is determined that a detailed description of related known technologies related to the present disclosure may unnecessarily obscure the subject matter of the present disclosure, a detailed description thereof will be omitted. In addition, terms to be described later are terms defined in consideration of functions in the present disclosure, which may vary according to the intention or custom of users or operators. Therefore, the definition should be made based on the contents throughout this specification. The terms used in the detailed description are only for describing embodiments, and should not be limiting. Unless explicitly used otherwise, expressions in the singular form include the meaning of the plural form. In this description, expressions such as “comprising” or “including” are intended to refer to certain features, numbers, steps, actions, elements, some or combination thereof, and it is not to be construed to exclude the presence or possibility of one or more other features, numbers, steps, actions, elements, some or combinations thereof, other than those described.

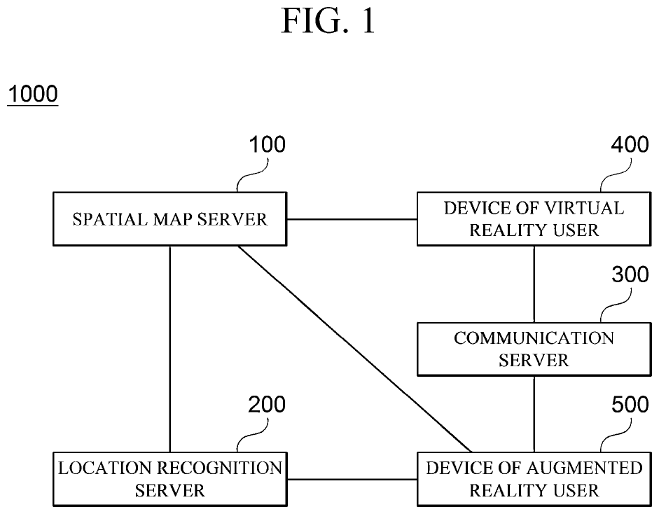

FIG. 1 is a block diagram illustrating an image processing system in a metaverse environment according to an embodiment of the present disclosure.

Referring to FIG. 1, an image processing system (hereinafter referred to as ‘image processing system’) 1000 in the metaverse environment includes a spatial map server 100, a location recognition server 200, a communication server 300, a device 400 of a virtual reality (VR) user, and a device 500 of an augmented reality (AR) user.

In more detail, the spatial map server 100 may generate a spatial map by using a point cloud and a plurality of viewpoint videos from a plurality of first real space images obtained by scanning a real space. The spatial map is defined as a map of the metaverse environment for enabling interaction between augmented reality and virtual reality on a mirror world constructed through virtualization of the real space.

Specifically, the spatial map server 100 may generate a spatial map through a process of acquiring a plurality of 360 image sets, generating an initial point cloud (point group) from a plurality of 360 images, generating an aligned point cloud through GPS alignment, combining topology, mesh, and point of interest (POI) into an aligned point cloud, extracting location recognition data, and generating the spatial map through an image photographing device such as a 360-degree camera and a LiDAR camera.

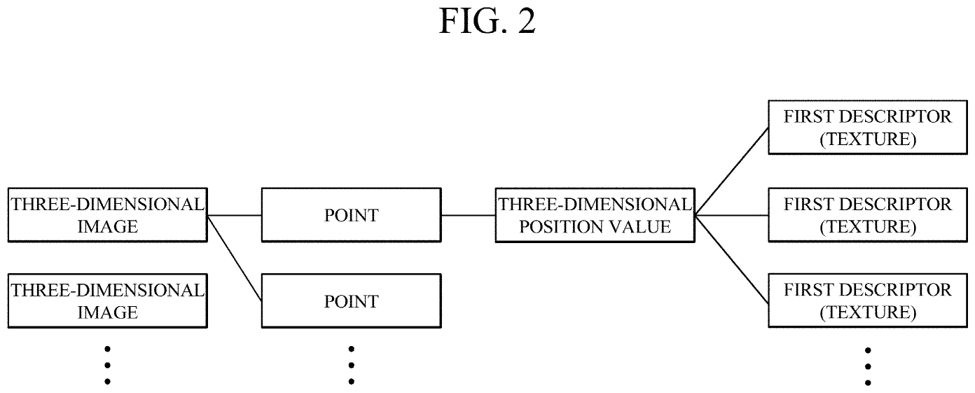

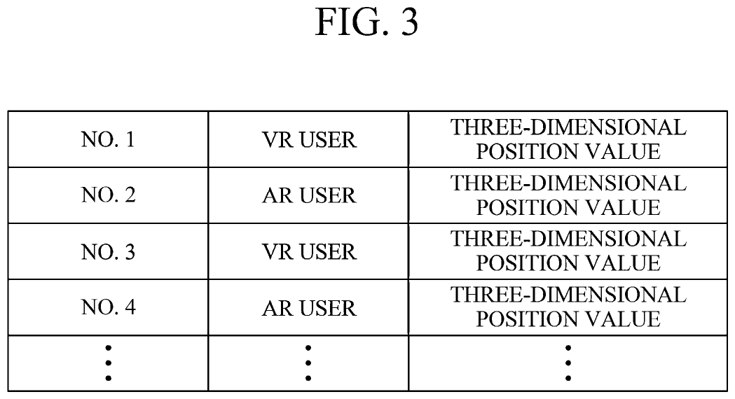

FIGS. 2 and 3 are exemplary diagrams for describing a method of identifying location information of a device of an AR user according to an embodiment of the present disclosure.

Referring to FIG. 2, location recognition data may include a three-dimensional position value of a point in a spatial map including a plurality of three-dimensional images and a plurality of first descriptors matched to the three-dimensional position value. That is, the three-dimensional position value and the first descriptor may have a one-to-many structure. In this case, the plurality of first descriptors may mean textures representing features in the image.

The spatial map server 100 may identify a location corresponding to the second real space image on the spatial map by using a second real space image photographed in real time from the device 500 of the AR user and the location information of the device 500 of the AR user, and overlay the second real space image on the identified location to provide the second real space image to the device 400 of the VR user. For example, the device 500 of the AR user may include, but is not limited to, a smartphone, a headset, smart glasses, various wearable devices, etc.

Since the location information of the device 500 of the AR user described above includes location coordinates and a gaze direction of the device 500 of the AR user, when the space map server overlays the second real space image on the space map, the space map server may not only overlap the location, but also the direction of the second real space image in consideration of the direction of the second real space image rather than simply overlapping the position. Due to this, it is possible to expect an effect that a sense of immersion may be increased from the perspective of a user who checks a state in which the second real space image is overlaid on the spatial map.

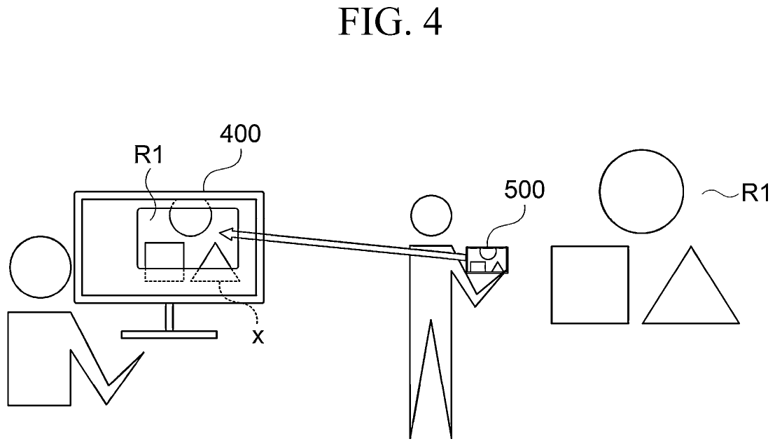

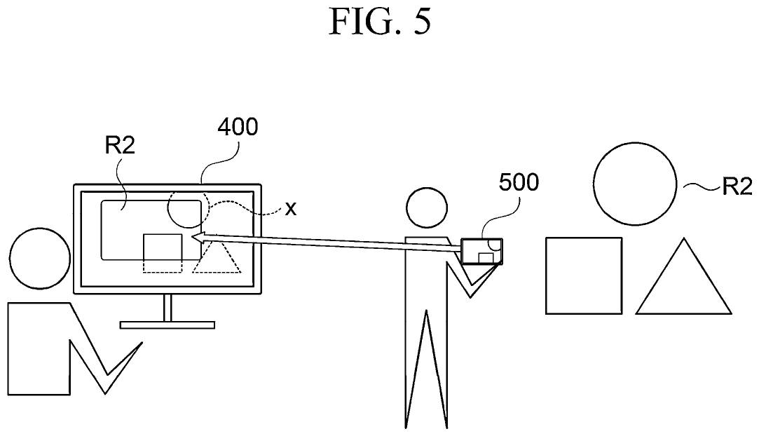

FIGS. 4 and 5 are exemplary diagrams for describing a case in which a real space image is reflected in the spatial map according to an embodiment of the present disclosure.

Referring to FIG. 4, the device 500 of the AR user may obtain a second real space image R1 in real time by photographing the real space. To this end, it will be natural that the device 500 of the AR user is provided with a device for photographing an image, including a camera. The second real space image R1 obtained by the device 500 of the AR user may be displayed by being overlapped on the corresponding position of a spatial map X output on the device 400 of the VR user. Due to this, the VR user may check the spatial map X with an increased sense of reality in which the second real space image is reflected in real time.

Referring to FIG. 5, the space map server 100 may reflect a second real space image R2 that is changed in real time as the device 500 of the AR user moves in the space map to provide the second real space image R2 to the device 400 of the VR user.

According to the principle of FIG. 5, since the space map server 100 reflects and provides the second real space image R, which is photographed while moving through the device 500 of the AR user on the space map in real time, a user who has accessed the spatial map may receive a metaverse environment with an increased sense of reality.

The subject of overlapping the second real space images R1 and R2 on the spatial map X described above may be the spatial map server 100, but is not limited thereto, and may also be implemented in the device 400 of the VR user to be described later.

The location recognition server 200 may store location recognition data extracted from the spatial map and compares the location recognition data with a second real space image obtained through the device 500 of the AR user to identify location information of the device 500 of the AR user on the spatial map.

The location recognition server 200 may compare the plurality of first descriptors extracted from the location recognition data with a plurality of second descriptors extracted from the second real space image to identify the location information of the device 500 of the AR user including the location coordinates and the gaze direction of the device 500 of the AR user on the spatial map.

Specifically, the location recognition server 200 may obtain the plurality of second descriptors by extracting characteristic regions from the second real space image. The characteristic regions may be protruding portions or regions matching a condition set as characteristics in advance by an operator. In this case, the plurality of second descriptors may match a two-dimensional position value. Next, the location recognition server 200 may compare the plurality of second descriptors with the plurality of first descriptors to search for and find first descriptors that match each other. Next, the location recognition server 200 identifies at which location the device 500 of the AR user photographed the image based on the 3D position value corresponding to the matched first descriptors and the 2D position value corresponding to the second descriptors.

The location recognition server 200 may provide the identified location information of the device 500 of the AR user to the device 500 of the AR user. The device 500 of the AR user may transmit its location information to the communication server 300, but is not limited thereto, and may also provide the location information to the spatial map server 100.

The communication server 300 may be a configuration for storing and providing the location information of the device 500 of the AR user on the spatial map and the location of the VR user on the spatial map, and displaying at least one or more AR users and at least one or more VR users on the spatial map in synchronization with one another by using the location information and the location.

That is, as illustrated in FIG. 3, the communication server 300 collects and manages whether or not users (No. 1 to No. 4, etc.) accessing the communication server 300 are AR users or VR users, and their respective locations (e.g., location information of the device of the AR user or location information of the device of the VR user) are, and provides the collected and managed data to a configuration that needs them.

In this case, the location information of the device of the AR user and the location of the VR user may be in the form of a three-dimensional location value.

For example, the communication server 300 may broadcast the location information of the device of the AR user and the location of the device of the VR user to the device 400 of the VR user, the device 500 of the AR user, etc.

The location of the VR user may mean a location on a map (e.g., a spatial map) accessed through the device 400 of the VR user. For example, the VR user may select a specific location of the spatial map through an input unit (not illustrated) provided in the device 400 of the VR user. In this case, the location of the selected spatial map may be the location of the VR user. Alternatively, the location of the VR user may be the current location that is tracked as the VR user moves automatically or manually on the spatial map.

The communication server 300 may identify the at least one or more AR users or the at least one or more VR users existing on the same spatial map by identifying, based on the location information of the device 500 of the AR and the location of the VR user, whether or not a condition including at least one or more of proximity of the AR user and VR user to each other, whether or not the AR user and VR user exist within a specific region, whether or not the AR user and VR user use a specific service, and whether or not the AR user and VR user belong to the same group is satisfied. The same group may mean a group matched in advance with members such as friends, co-workers, acquaintances, and club members.

In these embodiments, existence on the same spatial map may mean a member within a group that may receive the same specific service from the communication server 300. For example, the communication server 300 may provide a service to enable interaction such as a video call, a chat service, or an information transmission service such as a 3D video, an image, and a URL between AR users, between VR users, or between AR users and VR users, existing on the same spatial map.

For example, the specific region described above may be a region which is set arbitrarily, such as a store A, a cinema B, a restaurant C, a theater D, etc. in a department store.

If the spatial map is the store A of the department store, the VR user may be a customer and the AR user may be a clerk of the store. In this case, the VR user may check various images including a product image of the store A that the clerk of the store A, who is the AR user, photographs in real time through the device 500 of the AR user, through the device 400 of the VR user.

The communication server 300 may provide at least one or more services of a chat service, a video call service, and a data transmission service between at least one or more AR users and at least one or more VR users located on the same spatial map.

Specifically, the communication server 300 collects service-related information (e.g., chat content, transmitted data, video call images, etc.) made between users accessing the same spatial map, and provides the service-related information back to the corresponding devices.

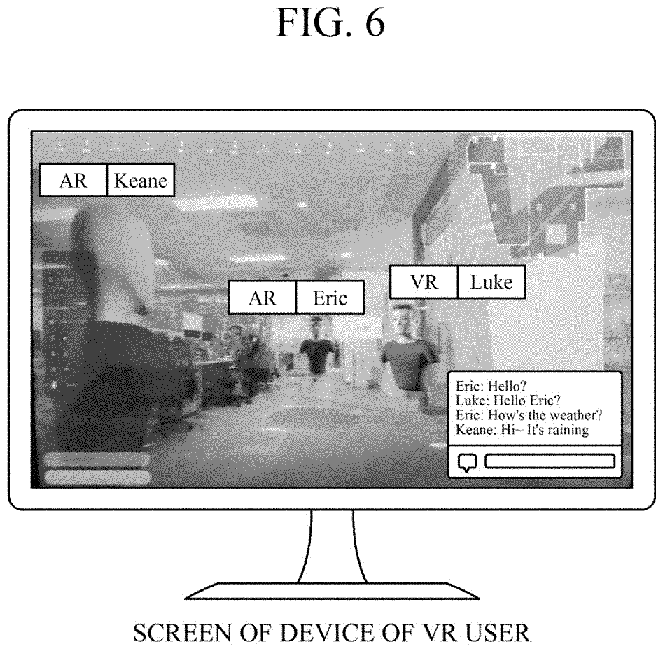

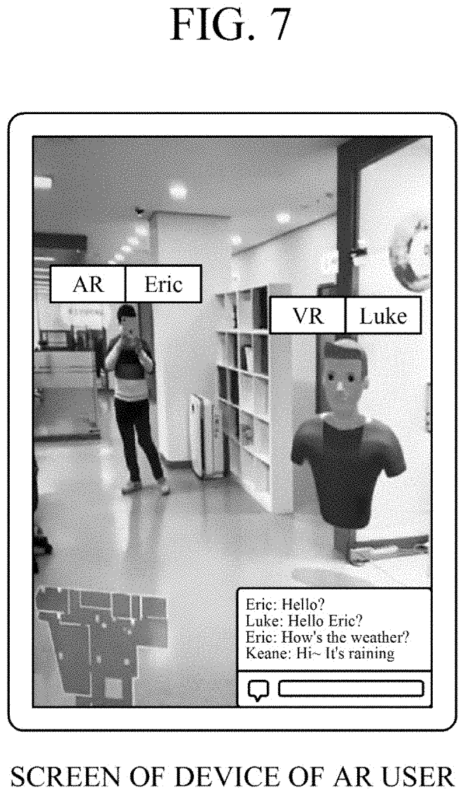

The communication server 300 may display so that the users who have accessed the same spatial map may check the other party. For example, the communication server may display the names (name, nickname) of users who have accessed the same spatial map in a list format, or match the names to respective avatars (see FIGS. 6 and 7) and display them on the screens of the device 500 of the AR user and the device 400 of the VR user.

The device 400 of the VR user may identify a location corresponding to the second real space image on the spatial map by using the second real space image photographed in real time from the device 500 of the AR user and the location information of the device 500 of the AR user, and overlay the second real space image on the identified location to display the second real space image on a screen. In this case, the spatial map may be a VR map.

If the device 400 of the VR user is using the video call service with the device 500 of the AR user, the second real space image may be a face image of the AR user photographed by the device 500 of the AR user or a background image. That is, when the video call service is being used, the device 400 of the VR user overlaps the second real space image on a spatial map provided by default and outputs the second real space image on the screen.

As an example, the device 400 of the VR user may receive the space map from the space map server 100 and display the space map on the screen, and overlay the second real space image on the space map based on the location information (location coordinates and gaze direction) of the device 500 of the AR user received from the communication server 300.

As another example, the device 400 of the VR user may store the spatial map and overlay the second real space image on the stored spatial map.

FIG. 6 is an exemplary diagram of a screen of a device of a VR user according to an embodiment of the present disclosure.

Referring to FIG. 6, the device 400 of the VR user may include the AR user on the spatial map and display the AR user on the screen by using the location information of the device 500 of the AR user.

For example, the device 400 of the VR user may display the avatars respectively representing an AR user and a VR user to be reflected on the spatial map.

FIG. 7 is an exemplary diagram of a screen of the device of the AR user according to an embodiment of the present disclosure.

Referring to FIG. 7, the device 500 of the AR user may display the VR user on the second real space image photographed in real time by using the location of the VR user on the spatial map transmitted from the communication server 300. In addition, the device 500 of the AR user may also display another AR user on the screen.

For example, the device 500 of the AR user may display another AR user and a VR user on the second real space image, but the VR user may be displayed in the form of an avatar.

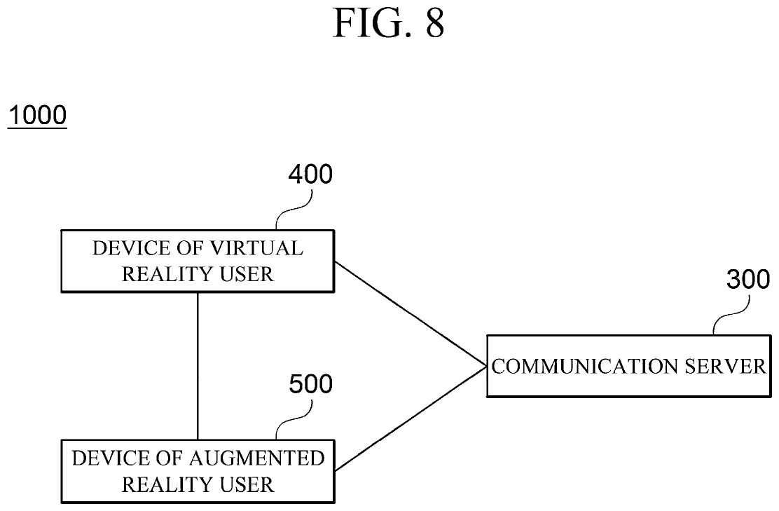

FIG. 8 is a block diagram for describing an image processing system in a metaverse environment according to another embodiment of the present disclosure.

Referring to FIG. 8, the image processing system 1000 includes the communication server 300, the device 400 of the VR user, and the device 500 of the AR user.

The device 400 of the VR user may store the spatial map generated by using a point cloud and a plurality of viewpoint videos from a plurality of first real space images, identify a location corresponding to a second real space image photographed in real time from the device of the AR user on the spatial map by using the second real space image and location information of the device 500 of the AR user, and overlay the second real space image on the identified corresponding location of the spatial map to display the second real space image on the screen.

The device 400 of the VR user may include the AR user on the spatial map and display the AR user on the screen by using the location information of the device 500 of the AR user.

The device 500 of the AR user may store the location recognition data extracted from the spatial map, and compare the location recognition data with the second real space image obtained by scanning the real space to identify and provide its location information on the space map.

The device 500 of the AR user may compare the plurality of first descriptors extracted from the location recognition data with a plurality of second descriptors extracted from the second real space image to identify the location information of the device of the AR user including location coordinates and a gaze direction of the device 500 of the AR user on the spatial map.

The device 500 of the AR user may display the VR user on the second real space image photographed in real time by using the location of the VR user on the spatial map transmitted from the device 400 of the VR user.

The communication server 300 may store and provide the location information of the device 500 of the AR user on the spatial map and the location of the VR user on the spatial map, and display at least one or more AR users and at least one or more VR users on the spatial map in synchronization with one another by using the location information and the location.

The communication server 300 may identify the at least one or more AR users or the at least one or more VR users existing on the same spatial map by identifying, based on the location information of the device 500 of the AR and the location of the VR user, whether or not a condition including at least one or more of proximity of the AR user and VR user to each other, whether or not the AR user and VR user exist within a specific region, whether or not the AR user and VR user use a specific service, and whether or not the AR user and VR user belong to the same group is satisfied.

The communication server 300 may provide at least one of a chat service, a video call service, and a data transmission service between the at least one or more AR users and the at least one or more VR users located on the same spatial map.

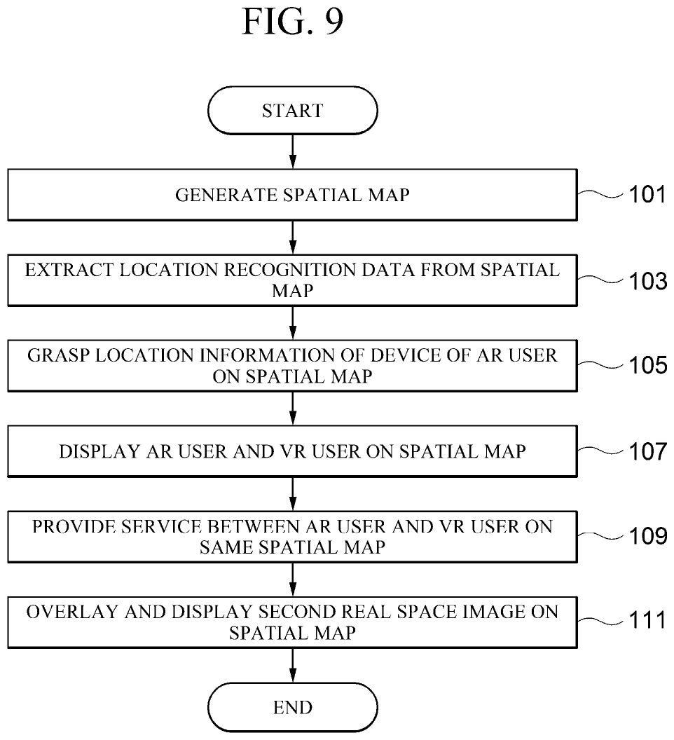

FIG. 9 is a flowchart for describing an image processing method in a metaverse environment according to an embodiment of the present disclosure. The method illustrated in FIG. 9 may be performed, for example, by the image processing system 1000 described above. In the illustrated flowchart, the method described above has been described by dividing the method into a plurality of steps, but at least some of the steps may be performed in a different order, performed in combination with other steps, or omitted, performed by being divided into detailed steps, or performed by being added with one or more steps (not illustrated).

In step 101, the image processing system 1000 may generate a spatial map by using the point cloud and the plurality of viewpoint videos from the plurality of first real space images obtained by scanning real space.

In step 103, the image processing system 1000 may extract location recognition data from the spatial map.

In step 105, the image processing system 1000 may compare the location recognition data with the second real space image obtained through the device 500 of the AR user to identify location information of the device 500 of the AR user on the spatial map. The location recognition data may include a three-dimensional location value of a point in the spatial map and a plurality of first descriptors matching the three-dimensional location value.

Specifically, the image processing system 1000 may receive the second real space image photographed by the device 500 of the AR user.

Next, the image processing system 1000 may extract a two-dimensional position value of a point in the second real space image and a plurality of second descriptors matched to the two-dimensional position value.

Next, the image processing system 1000 may compare the plurality of first descriptors with the plurality of second descriptors to identify the location information of the device 500 of the AR user including the location coordinates and the gaze direction of the device 500 of the AR user on the spatial map.

In step 107, the image processing system 1000 may display at least one or more AR users and at least one or more VR users on the spatial map in synchronization with one another by using the location information of the device 500 of the AR user and the location of the device of the VR user on the spatial map.

The image processing system 1000 may identify the at least one or more AR users or the at least one or more VR users existing on the same spatial map by identifying, based on the location information of the device 500 of the AR and the location of the VR user, whether or not a condition including at least one or more of proximity of the AR user and VR user to each other, whether or not the AR user and VR user exist within a specific region, whether or not the AR user and VR user use a specific service, and whether or not the AR user and VR user belong to the same group is satisfied.

In step 109, the image processing system 1000 may provide at least one of a chat service, a video call service, and a data transmission service between the at least one or more AR users and the at least one or more VR users located on the same spatial map.

In step 111, the image processing system 1000 may overlay the second real space image on the spatial map to be displayed thereon.

Specifically, the image processing system 1000 may identify a location corresponding to the second real space image on the spatial map by using the second real space image photographed in real time from the device 500 of the AR user and the location information of the device 500 of the AR user.

The image processing system 1000 may overlay the second real space image on the corresponding position of the identified spatial map to be displayed thereon.

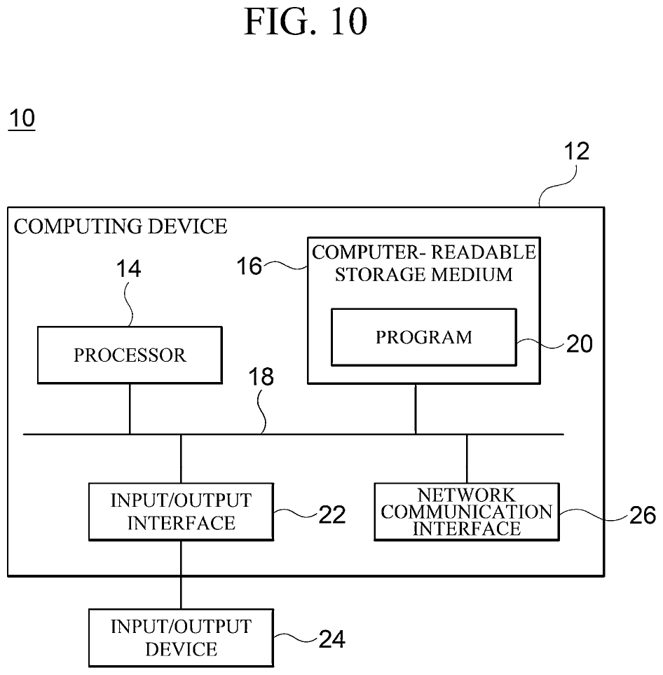

FIG. 10 is a block diagram illustratively describing a computing environment 10 including a computing device suitable for use in exemplary embodiments. In the illustrated embodiment, respective components may have different functions and capabilities other than those described below, and may include additional components in addition to those described below.

The illustrated computing environment 10 includes a computing device 12. In an embodiment, the computing device 12 may be the spatial map server 100, the location recognition server 200, the communication server 300, the device 400 of the VR user, or the device 500 of the AR user.

The computing device 12 includes at least one processor 14, a computer-readable storage medium 16, and a communication bus 18. The processor 14 may cause the computing device 12 to operate according to the exemplary embodiment described above. For example, the processor 14 may execute one or more programs stored on the computer-readable storage medium 16. The one or more programs may include one or more computer-executable instructions, which, when executed by the processor 14, may cause the computing device 12 to perform operations according to the exemplary embodiment.

The computer-readable storage medium 16 is configured such that the computer-executable instruction or program code, program data, and/or other suitable forms of information are stored. A program 20 stored in the computer-readable storage medium 16 includes a set of instructions executable by the processor 14. In one embodiment, the computer-readable storage medium 16 may be a memory (volatile memory such as a random access memory, non-volatile memory, or any suitable combination thereof), one or more magnetic disk storage devices, optical disk storage devices, flash memory devices, other types of storage media that are accessible by the computing device 12 and capable of storing desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 through the input/output interface 22. The exemplary input/output device 24 may include a pointing device (such as a mouse or trackpad), a keyboard, a touch input device (such as a touch pad or touch screen), a voice or sound input device, input devices such as various types of sensor devices and/or photographing devices, and/or output devices such as a display device, a printer, a speaker, and/or a network card. The exemplary input/output device 24 may be included inside the computing device 12 as a component constituting the computing device 12, or may be connected to the computing device 12 as a separate device distinct from the computing device 12.

Although the present disclosure has been described in detail through representative embodiments above, those skilled in the art to which the present disclosure pertains will understand that various modifications may be made thereto within the limits that do not depart from the scope of the present disclosure. Therefore, the scope of rights of the present disclosure should not be limited to the described embodiments, but should be defined not only by claims set forth below but also by equivalents of the claims.

What is claimed is:

1. An image processing system in a metaverse environment, comprising:
a spatial map server configured to generate a spatial map by using a point cloud and a plurality of viewpoint videos from a plurality of first real space images obtained by scanning real space;
a location recognition server configured to store location recognition data extracted from the spatial map, and compare the location recognition data with a second real space image obtained through a device of an AR user to identify location information of the device of the AR user on the spatial map; and
a communication server configured to store and provide the location information of the device of the AR user on the spatial map and a location of a VR user on the spatial map, and display at least one or more AR users and at least one or more VR users on the spatial map in synchronization with each other by using the location information and the location.

2. The system of claim 1, wherein the location recognition data includes a three-dimensional location value of a point in the spatial map and a plurality of first descriptors matched to the three-dimensional location value.

3. The system of claim 2, wherein the location recognition server compares the plurality of first descriptors extracted from the location recognition data with a plurality of second descriptors extracted from the second real space image to identify the location information of the device of the AR user including location coordinates and a gaze direction of the device of the AR user on the spatial map.

4. The system of claim 1, wherein the communication server identifies the at least one or more AR users or the at least one or more VR users existing on the same spatial map by identifying, based on the location information of the device of the AR and the location of the VR user, whether or not a condition including at least one or more of proximity of the AR user and VR user to each other, whether or not the AR user and VR user exist within a specific region, whether or not the AR user and VR user use a specific service, and whether or not the AR user and VR user belong to the same group is satisfied.

5. The system of claim 4, wherein the communication server provides at least one or more services of a chat service, a video call service, and a data transmission service between the at least one or more AR users and the at least one or more VR users located on the same spatial map.

6. The system of claim 1, wherein the spatial map server identifies a location corresponding to the second real space image on the spatial map by using the second real space image photographed in real time from the device of the AR user and the location information of the device of the AR user, and overlay the second real space image on the identified location on the spatial map to provide the second real space image to the device of the VR user.

7. The system of claim 1, further comprising:
a device of a VR user configured to identify a location corresponding to the second real space image on the spatial map by using the second real space image photographed in real time from the device of the AR user and the location information of the device of the AR user, and overlay the second real space image on the identified location on the spatial map to display the second real space image on a screen.

8. The system of claim 7, wherein the device of the VR user displays the spatial map on the screen by including the AR user on the spatial map by using the location information of the device of the AR user.

9. The system of claim 1, further comprising:
a device of an AR user configured to display the VR user on the second real space image photographed in real time by using the location of the VR user on the spatial map transmitted from the communication server.

10. An image processing system in a metaverse environment comprising:
a device of a VR user configured to store a spatial map generated by using a point cloud and a plurality of viewpoint videos from a plurality of first real space images, identify a location corresponding to a second real space image photographed in real time from a device of an AR user on the spatial map by using the second real space image and location information of the device of the AR user, and overlay the second real space image on the identified corresponding location of the spatial map to display the second real space image on a screen;
the device of the AR user configured to store location recognition data extracted from the spatial map, compare the location recognition data with the second real space image obtained by scanning real space, and identify and provide location information of the device of the AR user on the spatial map; and
a communication server configured to store and provide the location information of device of the AR user on the spatial map and a location of a VR user on the spatial map, and display at least one or more AR users or at least one or more VR users on the spatial map in synchronization with each other by using the location information and the location.

11. The system of claim 10, wherein the device of the AR user compares a plurality of first descriptors extracted from the location recognition data with a plurality of second descriptors extracted from the second real space image to identify the location information of the device of the AR user including location coordinates and a gaze direction of the device of the AR user on the spatial map.

12. The system of claim 10, wherein the device of the VR user displays the spatial map on the screen by including the AR user on the spatial map by using the location information of the device of the AR user.

13. The system of claim 10, wherein the communication server identifies the at least one or more AR users or the at least one or more VR users existing on the same spatial map by identifying, based on the location information of the device of the AR and the location of the VR user, whether or not a condition including at least one or more of proximity of the AR user and VR user to each other, whether or not the AR user and VR user exist within a specific region, whether or not the AR user and VR user use a specific service, and whether or not the AR user and VR user belong to the same group is satisfied.

14. The system of claim 13, wherein the communication server provides at least one or more services of a chat service, a video call service, and a data transmission service between the at least one or more AR users and the at least one or more VR users located on the same spatial map.

15. The system of claim 10, wherein the device of the AR user displays the VR user on the second real space image photographed in real time by using the location of the VR user on the spatial map transmitted from the device of the VR user.

16. An image processing method in a metaverse environment comprising:
generating a spatial map by using a point cloud and a plurality of viewpoint videos from a plurality of first real space images obtained by scanning real space;
extracting location recognition data from the spatial map;
identifying location information of a device of an AR user on the spatial map by comparing the location recognition data with a second real space image obtained through the device of the AR user; and
displaying at least one or more AR users and at least one or more VR users on the spatial map in synchronization with one another by using the location information of the device of the AR user and a location of a VR user on the spatial map.

17. The method of claim 16, wherein the location recognition data includes a three-dimensional location value of a point in the spatial map and a plurality of first descriptors matched to the three-dimensional location value; and
the identifying of the location information of the device of the AR user comprises:
receiving the second real space image photographed by the device of the AR user;
extracting a two-dimensional position value of a point in the second real space image and a plurality of second descriptors matching to the two-dimensional position value; and
determining location information of the device of the AR user including location coordinates and a gaze direction of the device of the AR user on the spatial map by comparing the plurality of first descriptors with the plurality of second descriptors.

18. The method of claim 17, wherein, in the displaying of the at least one or more AR users and the at least one or more VR users, the at least one or more AR users or the at least one or more VR users existing on the same spatial map are identified by identifying, based on the location information of the device of the AR and the location of the VR user, whether or not a condition including at least one or more of proximity of the AR user and VR user to each other, whether or not the AR user and VR user exist within a specific region, whether or not the AR user and VR user use a specific service, and whether or not the AR user and VR user belong to the same group is satisfied.

19. The method of claim 18, further comprising:
after the displaying of the at least one or more AR users and at least one or more VR users on the spatial map in synchronization with each other,
providing at least one or more services of a chat service, a video call service, and a data transmission service between the at least one or more AR users and the at least one or more VR users located on the same spatial map.

20. The method of claim 18, further comprising:
after the displaying of the at least one or more AR users and at least one or more VR users on the spatial map in synchronization with each other,
identifying a location corresponding to the second real space image on the spatial map using the second real space image photographed in real time from the device of the AR user and the location information of the device of the AR user; and
overlaying the second real space image on the identified location to display the second real space image on the identified location of the spatial map.
